(19) United States
(12) Patent Application Publication
(10) Pub. No.: US 2017/0122253 A1
(43) Pub. Date: May 4, 2017

(54) Hot air engine/heat pump

(71) Applicants: Gabriel Justin Kohlmeyer, Dane, WI (US); Matthew Jared Kohlmeyer, Saint Francis, WI (US)

(72) Inventors: Gabriel Justin Kohlmeyer, Dane, WI (US); Matthew Jared Kohlmeyer, Saint Francis, WI (US)

(21) Appl. No.: 15/340,928

(22) Filed: Nov. 1, 2016

Related U.S. Application Data
(60) Provisional application No. 62/285,539, filed on Nov. 2, 2015.

(51) Int. Cl. F02G 1/044; F02G 1/053

(52) U.S. Cl. CPC F02G 1/044; F02G 1/0535; F02G 2280/20

(57) ABSTRACT

A closed cycle heat engine having working fluid sealed between pistons of different diameters, that are connected by a piston rod, within cylinders that create air tight seals with the pistons. It can also be used as a heat pump.

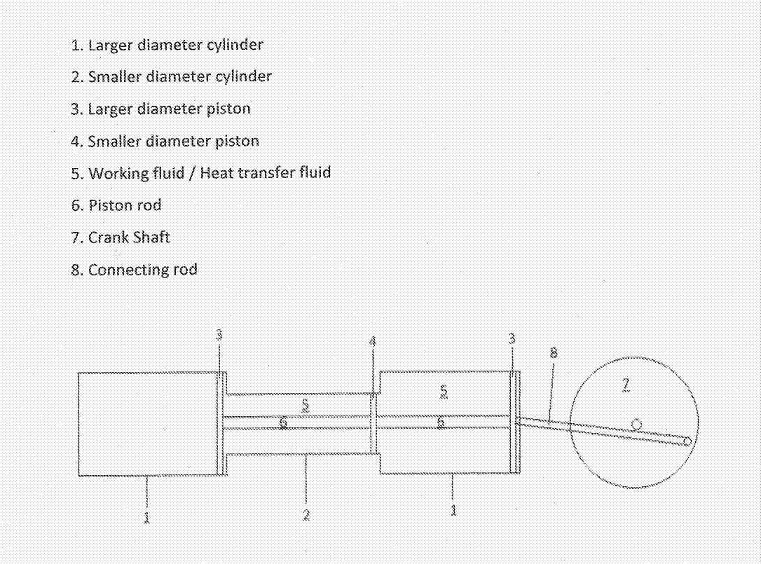

### CROSS-REFERENCE TO RELATED APPLICATIONS

Cross-Reference to U.S. provisional application No. 62/285,539, Hot air engine/heat pump, filing date Nov. 2, 2015 is made here and in the application data sheet.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Hot air engines have been around for a long time. They work by using the expansion and contraction of air under the influence of a temperature change to convert thermal energy into mechanical work. Wikipedia has a hot air engine page. The main problem with closed cycle hot air engines is the power to weight ratio.

### BRIEF SUMMARY OF THE INVENTION

This hot air engine/heat pump is a dosed cycle, external combustion engine, which could also be used as a heat pump. It has working fluid sealed between pistons of different diameters that are connected together by a piston rod, in cylinders with diameters to fit the pistons. The mode of operation with three pistons and cylinders as shown in the drawing, should have a higher power to weight ratio than other dosed cycle hot air engines, due to the heat source continuously heating working fluid and cooling cylinders which are cooled internally and externally by external air.

### BRIEF DESCRIPTION OF THE SEVERAL VIEWS OF THE DRAWING

There is only one drawing. It shows the parts of the engine,

### DETAILED DESCRIPTION OF THE INVENTION

This hot air engine/heat pump, of the dosed cycle type, is comprised of pistons of different diameters, connected by a piston rod; cylinders made of thermally conductive material and of diameters to make an air tight seal with the pistons; working fluid or heat transfer fluid, and a means of converting the mechanical energy from reciprocating motion. The best mode of operation would be three pistons and three cylinders as in the drawing.

Operation of this hot air engine/heat pump involves expansion and/or contraction of a unit of mass of working fluid or heat transfer fluid, between 2 pistons of different diameters that are connected by a rod and synchronously moving in tandem arrangement, within thermally conductive cylinders. The pistons, being of different diameters, cause the fluid pressure between them to apply more force to the larger diameter piston, forcing the pistons and shaft toward one end of the cylinder or the other. Different methods of mechanical timing may cause the efficiency or power to benefit.

To use as an engine, a heat source is applied to the smaller diameter cylinder. The Larger diameter cylinder acts as a heat sink, the working fluid is moved hack and forth between the hot and cold cylinders by the pistons, causing the temperature and pressure of the working fluid to increase and decrease, driving the pistons back and forth. the mechanical energy created can be transferred through a crankshaft or any other method utilizing the back and forth motion.

To use as a heat pump, a mechanical means of moving the pistons back and forth causes the heat transfer fluid to be compressed and expanded, increasing and decreasing its temperature, drawing heat from the larger diameter cylinder and transferring it to the smaller diameter cylinder.

1. A dosed cycle heat engine comprising: working fluid, sealed between multiple pistons of different diameters that are connected by a piston rod; thermally conductive cylinders of diameters that create air tight seals with the pistons; and a means of converting reciprocating motion to do useful work.

2. The closed cycle heat engine of claim 1, wherein said cylinders that have pistons exposed to external air, are cooled externally and internally by external air.

3. The closed cycle heat engine of claim 1, wherein said pistons are driven, causing it to act as a heat pump.
